(19) United States
(12) Patent Application Publication
(10) Pub. No.: US 2018/0013324 A1
(43) Pub. Date: Jan. 11, 2018

(54) Electric Compressor

(71) Applicant: SANDEN HOLDINGS CORPORATION, Isesaki-shi (JP)

(72) Inventor: Tetsuya TAKABE, Isesaki-shi (JP)

(21) Appl. No.: 15/545,482

(22) PCT Filed: Jan. 21, 2016
(86) PCT No.: PCT/JP2016/051689

§ 371 Date: Jul. 21, 2017

(30) Foreign Application Priority Data
Jan. 27, 2015 (JP) 2015-013452

(51) Int. Cl. H02K 1/18; H02K 5/24; H02K 1/20; H02K 3/52; H02K 1/14

(52) U.S. Cl. CPC H02K 1/185; H02K 5/24; H02K 1/20; H02K 1/187; H02K 1/146; H02K 3/522

(57) ABSTRACT

Electric compressor 1 has electric motor 10 housed in casing 40, the motor including stator 2 having yoke portion 2a and plural tooth portions 2b, and rotor 3 disposed radially inside stator 2. Protrusion 41f protrudes at plural circumferential positions of inner periphery 41a1 of casing 40, which has protruding end surface 41f1 contacting an outer periphery of yoke portion 2a with width larger than tooth portion 2b. Contact tooth back portion 2a11 contacts protruding end surface 41f1, out of plural tooth back portions 2a1 each disposed behind tooth portion 2b as part of the outer periphery of yoke portion 2a, is formed in a region except both edge portions 41h of protruding end surface 41f1 in a circumferential direction within a circumferential angle range θ in which the protruding end surface 41f1 is located.

### TECHNICAL FIELD

The present invention relates to an electric compressor which is used for compressing refrigerant in a vehicle air conditioner or the like, and which integrally includes a compression mechanism and an electric motor for driving the compression mechanism.

### BACKGROUND ART

This type of electric compressor is disclosed, for example, in Patent Document 1. In the electric compressor disclosed in Patent Document 1, an electric motor and a compression mechanism are housed in a casing. The electric motor includes an annular stator having an annular yoke portion and tooth portions that are formed protruding at plural positions spaced apart in a circumferential direction of the inner periphery of the yoke portion, and a rotor that has plural magnetic poles and is disposed radially inside the stator. The compression mechanism is driven by the electric motor.

Also, as is commonly practiced in such an electric compressor, plural recesses are formed at plural positions spaced apart in a circumferential direction of the outer periphery of the stator, and the stator is fixed to the casing such that plural portions other than the recesses are used as shrink-fit positions.

### REFERENCE DOCUMENT LIST

### Patent Document

Patent Document 1: JP 2011-196212 A

### SUMMARY OF THE INVENTION

### Problems to be Solved by the Invention

Here, in electric compressors equipped with a so-called inner rotor type electric motor, like the above electric compressor, in which a rotor having plural magnetic poles is disposed radially inside the stator with plural tooth portions, when an appropriate phase current is supplied to coil on the respective tooth portions, an electromagnetic force acts on the respective tooth portions. Consequently, the respective tooth portions, etc. vibrate deformed slightly in the radial direction at a timing corresponding to the phase of current supplied to the coil thereon, etc. while a magnetic force is being applied. The vibrations generated in the stator (tooth portions, etc.) are transmitted to the casing by way of the shrink-fit positions, and thus generate noise.

To reduce such vibration transmission from the stator to the casing, an area of a shrink-fit portion between the stator and the casing is reduced by forming the recess as described above to make the shrink-fit portion area discontinuous in the circumferential direction.

However, in order to secure the force enough to hold the stator, the shrink-fit portion should be wide. Thus, a tooth back portion, located behind the tooth portion to constitute a part of the outer periphery of the yoke portion (i.e., the outer periphery of the stator), may possibly overlap the shrink-fit position (shrink-fit portion). To deal with such situation, further efforts are required to restrain vibration transmission.

The present invention has been made in view of the above circumstances and it is accordingly an object of the invention to provide an electric compressor that can properly restrain vibration transmission in case the tooth back portion overlaps the shrink-fit position.

### Means for Solving the Problems

According to an aspect of the present invention, there is provided an electric compressor which is driven by an electric motor and compresses refrigerant, and in which the electric motor is housed in a cylindrical casing, the motor including a stator having an annular yoke portion and a tooth portion formed protruding at a plurality of positions spaced apart in a circumferential direction of an inner periphery of the yoke portion, and a rotor disposed radially inside the stator, the electric compressor including a protrusion formed protruding at a plurality of positions spaced apart in a circumferential direction of an inner periphery of the casing, which has a protruding end surface that comes into contact with an outer periphery of the yoke portion and has a larger width than the tooth portion and which is used as a shrink-fit position with the yoke portion,

wherein a contact tooth back portion, which comes into contact with the protruding end surface, out of a plurality of tooth back portions each disposed behind the tooth portion to constitute a part of the outer periphery of the yoke portion, is formed in a region except both edge portions of the protruding end surface in a circumferential direction within a circumferential angle range in which the protruding end surface is located.

### Effects of the Invention

According to the electric compressor, although a part of the plural tooth back portions overlap the shrink-fit positions, a contact tooth back portion, which comes into contact with the protruding end surface of the protrusion, out of the plural tooth back portions, is formed in a region except both edge portions of the protruding end surface in a circumferential direction within a circumferential angle range in which the protruding end surface is located. Hence, it is possible to dispose the contact tooth back portion within the angle range where a pressure of contact with the yoke portion is relative low, in a region except, especially, each edge portion of the protruding end surface, which is more susceptible to high contact pressure. As a result, the transmission of vibrations from the contact tooth back portion to the protrusion can be restrained.

As mentioned above, it is possible to provide an electric compressor that can properly restrain the transmission of vibrations in case the tooth back portion overlaps the shrink-fit position.

### BRIEF DESCRIPTION OF THE DRAWINGS

FIG. 1 is a cross-sectional view of an electric compressor according to a first embodiment of the present invention.

FIG. 2 is a front view of the electric compressor as viewed in the direction of arrow A-A in FIG. 1.

FIG. 3 is a cross-sectional view of a main part as viewed in the direction of arrow B-B in FIG. 2.

FIG. 4 shows the electric compressor (first casing) of FIG. 3, from which a stator is removed.

FIG. 5 is a cross-sectional view of a main part as viewed in the direction of arrow C-C in FIG. 4.

FIG. 6 is an exploded perspective view of the stator and the first casing.

FIG. 7 is a perspective view of the electric motor in which the stator is housed in the first casing.

FIG. 8 shows distribution of a contact pressure applied to a shrink-fit position.

FIG. 9 is a conceptual diagram showing deformation of the stator having twelve slots in the electric compressor according to the embodiment.

FIG. 10 shows a first casing according to a second embodiment of the invention as viewed in the same direction as in FIG. 4.

FIG. 11 is an exploded perspective view of the stator and the first casing according to the second embodiment.

FIG. 12 is a perspective view of the electric motor in which the stator is housed in the first casing according to the second embodiment.

FIG. 13 is a conceptual diagram showing the force acting on the shrink-fit position according to the second embodiment.

FIG. 14 shows distribution of a contact pressure applied to the shrink-fit position according to the second embodiment.

### MODE FOR CARRYING OUT THE INVENTION

Hereinafter, an embodiment of the present invention will be described with reference to the accompanying drawings.

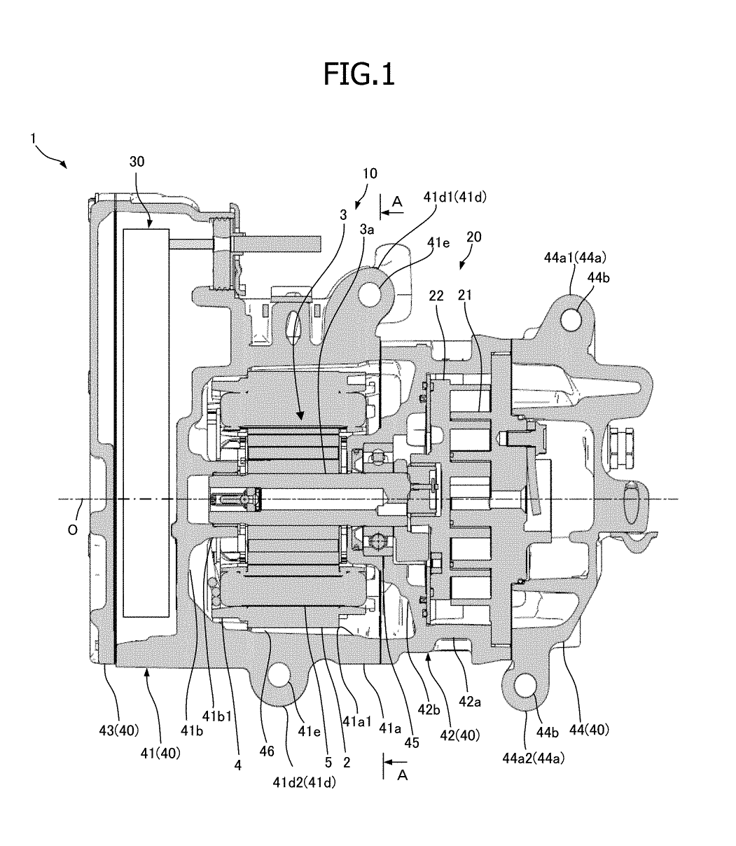

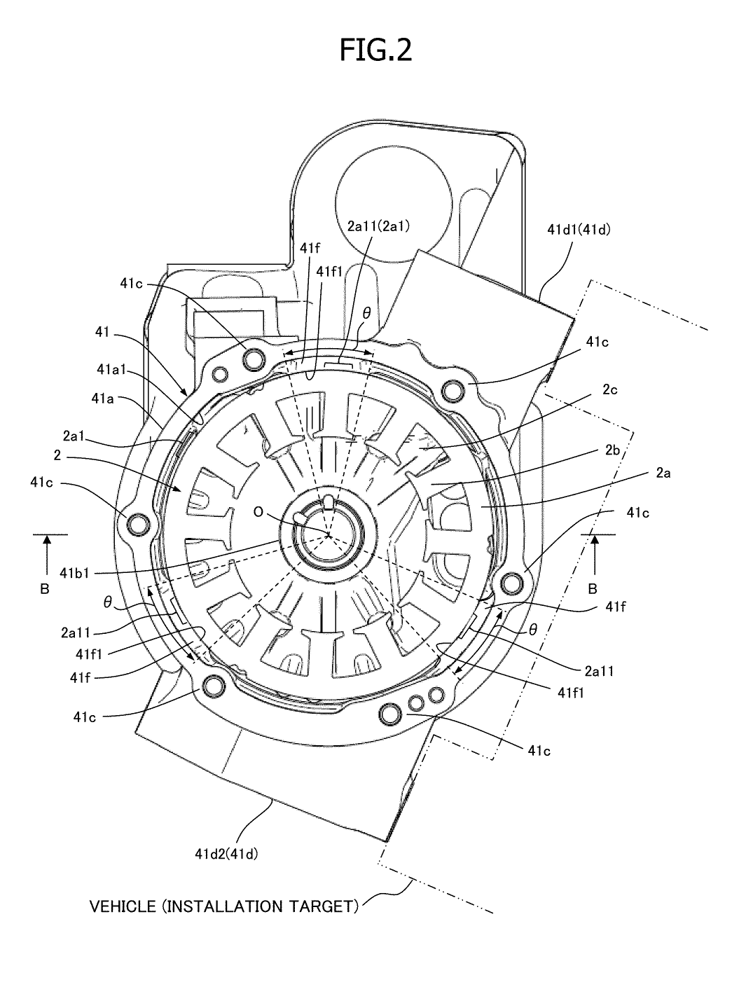

FIG. 1 is a cross-sectional view of an electric compressor according to a first embodiment of the present invention. FIG. 2 is a front view of the electric compressor as viewed in the direction of arrow A-A in FIG. 1.

An electric compressor 1 of this embodiment is provided, for example, in a refrigerant circuit for a vehicle air conditioner. The electric compressor 1 suctions and compresses refrigerant of the vehicle air conditioner and then, discharges the compressed refrigerant. The electric compressor 1 includes an electric motor 10, a compression mechanism 20 driven by the electric motor 10, an inverter 30 for driving the electric motor 10, and a cylindrical casing 40 which houses therein the electric motor 10, the compression mechanism 20 and the inverter 30. Note that illustration of components (e.g., rotor 3) other than a stator 2, which will be described later, of the electric motor 10 is omitted in FIG. 2 for simplification of the drawing.

As shown in FIG. 1, the electric motor 10 includes the annular stator 2, the rotor 3, bobbin 4, and coil 5. The bobbin 4, which provide electric insulation, are disposed at ends of the stator 2. The coil 5 is wound around the bobbin 4 and the stator 2. For example, the electric motor 10 may be a three-phase alternate-current motor. For example, the inverter 30 converts a direct current supplied by a vehicle battery (not shown) to an alternate current, and supplies the alternate current to the electric motor 10.

In this embodiment, the electric motor 10 is a three-phase alternate-current motor with eight magnetic poles and twelve slots.

As shown in FIG. 2, the stator 2 includes an annular back yoke 2a, and plural teeth 2b protruding radially inward from the inner periphery of the back yoke 2a. The stator is, for example, a laminate of silicon steel plates. The teeth 2b are formed protruding at plural positions spaced apart in the circumferential direction of the inner periphery of the back yoke 2a. A slot 2c is formed, open to the rotor side, between the teeth 2b.

In this embodiment, the stator 2 includes twelve teeth 2b and twelve slots 2c that are alternately arranged at regular intervals as shown in FIG. 2. In this embodiment, the back yoke 2a and the teeth 2b correspond to “yoke portion” and “tooth portion” of the present invention, respectively.

The rotor 3 is disposed radially inside the stator 2 and composed of plural magnetic poles (not shown). The rotor 3 is fit onto a rotation axis 3a and rotationally supported radially inside the stator 2. One end of the rotation axis 3a is rotationally supported by a support portion 41b1 formed in a first casing 41 as described later. The other end of the rotation axis 3a is inserted through a through hole formed in a second casing 42 as described later and rotationally supported by a bearing 45. The rotation axis 3a is fit, by shrink fitting, etc., into a through hole formed at the radially central portion of the rotor 3 and integrated with the rotor 3. When a magnetic field is generated in the stator 2 due to current supply from the inverter 30, a rotational force acts on the rotor 3, hereby rotating the rotation axis 3a. At the other end of the rotation axis 3a, a movable scroll 22, which will be described later, of the compression mechanism 20 is connected turnably.

In this embodiment, four N-pole permanent magnets and four S-pole permanent magnets are embedded in the rotor 3. That is, the rotor 3 has eight magnetic poles at regular intervals.

The compression mechanism 20 is driven by the electric motor 10 to compress the refrigerant. The compression mechanism 20 is housed in the below-described second casing 42 and disposed on the other end side of the rotation axis 3a of the rotor 3.

In this embodiment, the compression mechanism 20 is a scroll-type compressor composed of a fixed scroll 21 and the movable scroll 22. The movable scroll 22 moves around relative to the fixed scroll 21 so as to compress the refrigerant. The refrigerant compressed by the compression mechanism 20 is discharged from a discharge port.

In this embodiment, the electric compressor 1 is a so-called inverter-integrated compressor, and has the first casing 41, the second casing 42, an inverter cover 43, and a compression mechanism cover 44 as shown in FIG. 1. The first casing 41 houses therein the electric motor 10 and the inverter 30, and the second casing 42 houses therein the compression mechanism 20. The casings and covers (41, 42, 43 and 44) are formed by casting and integrally fastened with fastening means (not shown), such as bolts, so as to constitute the casing 40.

The first casing 41 includes an annular peripheral wall 41a and a partition wall 41b. The partition wall 41b divides the internal space of the first casing 41 into a space for housing the electric motor 10 and a space for housing the inverter 30. The inverter 30 is housed in the first casing 41 through an opening on one end side (the left side of FIG. 1) of the peripheral wall 41a, and the opening is closed by the inverter cover 43. The electric motor 10 is housed in the first casing 41 through an opening on the other end side (the right side of FIG. 1) of the peripheral wall 41a, and the opening is closed by the second casing 42 (a bottom wall 42b which will be described later). The partition wall 41b includes, at its radially central portion, a cylindrical support portion 41b1 for supporting one end of the rotation axis 3a of the electric motor 10. The support portion 41b1 protrudes toward the other end side of the peripheral wall 41a.

As shown in FIG. 2, a fastening portion 41c (boss) for fastening the first casing 41 to the second casing 42 is formed on the other end side of the first casing 41, at plural (six) positions spaced apart in the circumferential direction of the peripheral wall 41a. The fastening portions 41c are thicker than portions where the fastening portions 41c are not formed.

Also, in this embodiment, a fixing portion 41d is formed protruding from the outer periphery of the peripheral wall portion 41a of the first casing 41, in order to fix the first casing 41 (casing 40) to a vehicle as an installation target.

Specifically, as shown in FIGS. 1 and 2, the fixing portion 41d of the first casing 41 is composed of an upper fixing portion 41d1 and a lower fixing portion 41d2. The fixing portion 41d1, 41d2 has, for example, a through hole 41e (see FIG. 1) formed orthogonal to the axial line of the rotation axis 3a of the electric motor 10. The casing 40 (electric compressor 1) is fixed to the vehicle by inserting a bolt (not shown) into the through hole 41e and screwing the bolt into a screw hole formed in the vehicle.

As shown in FIG. 1, also at the position corresponding to the fixing portion (41d1, 41d2) of the first casing 41 on the outer periphery of the compression mechanism cover 44, a fixing portion 44a (upper fixing portion 44a1, lower fixing portion 44a2) for fixing to the vehicle is formed. A through hole 44b for inserting a bolt is also formed in the fixing portion (44a1, 44a2).

In this embodiment, a protrusion 41f is formed protruding at three positions spaced apart in the circumferential direction of the inner periphery 41a1 of the first casing 41. Each protrusion 41f has a protruding end surface 41f1 that comes into contact with the outer periphery of the back yoke 2a of the electric motor 10, and has a larger width than the tooth 2b of the electric motor 10. The protrusions are used as shrink-fit positions with the back yoke 2a.

Specifically, each protrusion 41f is formed to protrude radially inward from the inner periphery 41a1 of the casing 41, for example, to a radially inner position relative to the fastening portion 41c (i.e., radially inward beyond the fastening portion 41c), and extend in the axial direction of the first casing 41.

To be specific, as shown in FIG. 2, the protruding end surface (rotor side end surface) 41f1 of the protrusion 41f is formed in an arc shape in conformity with the outer peripheral shape of the stator 2 (more specifically, back yoke 2a) of the electric motor 10. Furthermore, there is a gap between the inner circle along each protruding end surface 41f1 and the inner surface of the fastening portion 41c.

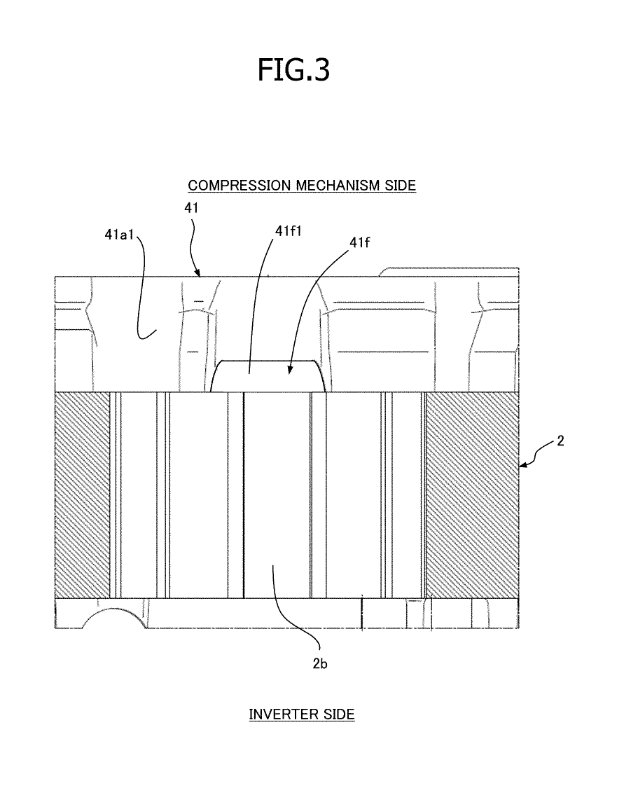

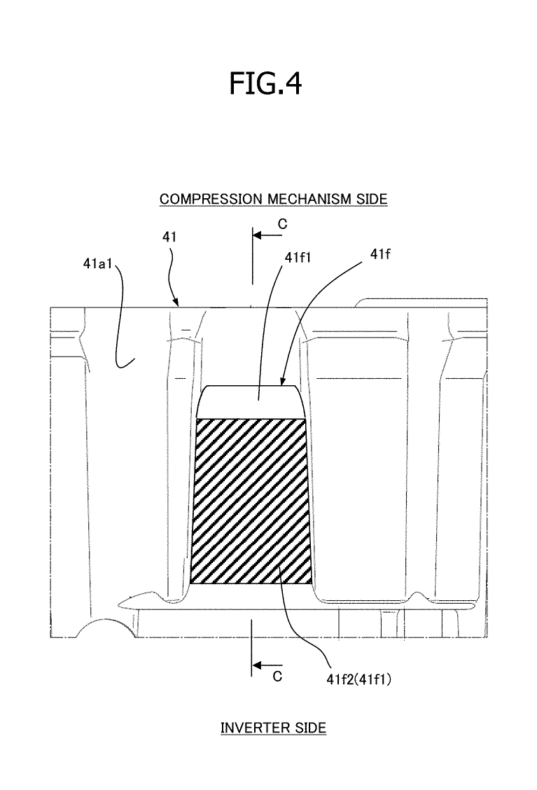

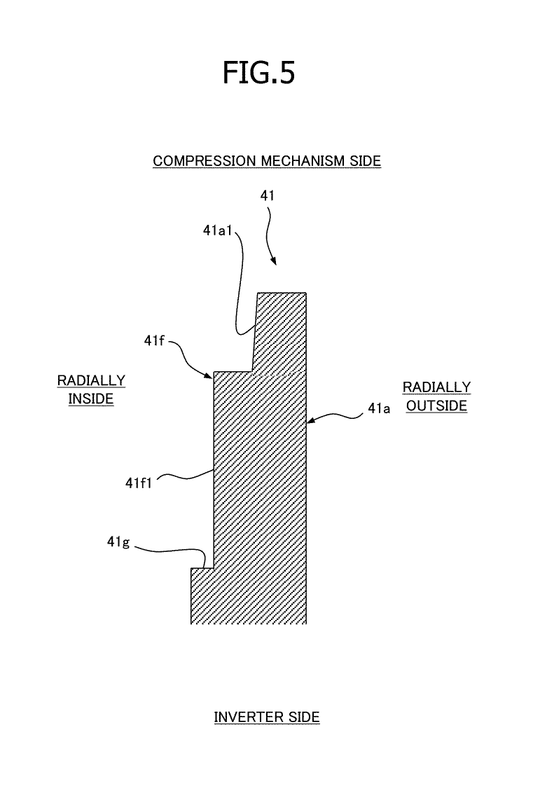

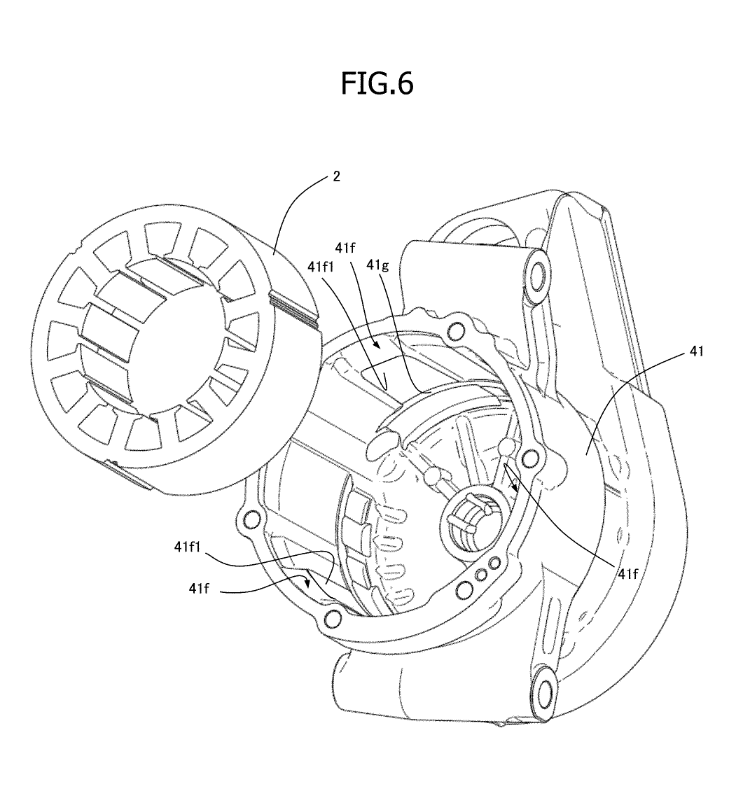

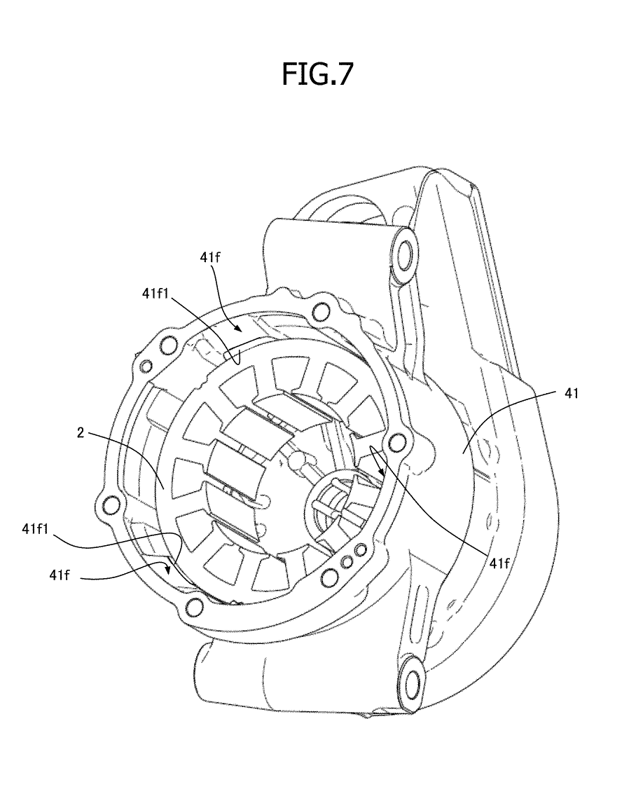

FIG. 3 is a cross-sectional view of a main part as viewed in the direction of arrow B-B in FIG. 2. FIG. 4 is a cross-sectional view of the electric compressor of FIG. 3 (first casing), from which the stator is removed. FIG. 5 is a cross-sectional view of a main part as viewed in the direction of arrow C-C in FIG. 4. FIG. 6 is an exploded perspective view of the stator and the first casing. FIG. 7 is a perspective view of the stator housed in the first casing.

More specifically, as shown in FIGS. 3 to 7, each protrusion 41f is formed on the inner periphery 41a1 of the peripheral wall portion 41a for housing the electric motor 10, has a much greater height (height in the axial direction) than the thickness (laminate thickness) of the stator 2, and protrudes at a height position close to the partition wall portion 41b (the inverter 30 side). As shown in FIGS. 5 and 6, a mounting seat 41g is formed so as to contact one end surface in the thickness direction of the back yoke 2a of the stator 2, along the inner periphery 41a1 on the partition wall portion 41b side of the protrusion 41f. FIGS. 3 and 7 show how the stator 2 is housed in the first casing 41, being in contact with the mounting seat 41g. As shown in FIGS. 3 and 7, the protruding end surface 41f1 is exposed at its one end in the axial direction (on the compression mechanism 20 side) not in contact with the outer periphery of the stator 2, and brought into contact, at the other end in the axial direction (inverter 30 side), with the outer periphery of the stator 2 (a hatched trapezoidal portion in FIG. 4 indicates a contact region 41f2 of the protruding end surface 41f1 that comes into contact with the outer periphery of the stator 2 and is used substantially as a shrink-fit position). The protrusion 41f is formed such that the diameter of the inner circle along the protruding end surface 41f1 is smaller than the outer diameter of the outer periphery of the stator 2 to be shrink-fit, in consideration of the shrink-fit margin.

The stator 2 is fixed to the casing 40 (first casing 41) by shrink-fitting at the protrusion 41f (specifically, the contact region 41f2) that is used as a shrink-fit position.

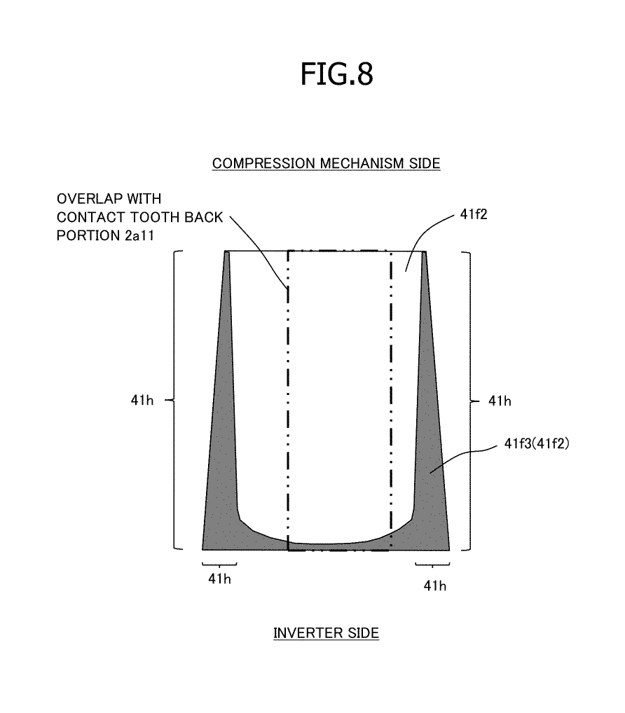

FIG. 8 is a conceptual diagram showing in shades the distribution of the contact pressure that is applied, after shrink-fitting, to the substantial shrink-fit position, that is, the trapezoidal contact region 41f2, of the protruding end surface 41f1 shown in FIG. 4. In FIG. 8, a dark area indicates an effective contact pressure region 41f3 having a contact pressure not smaller than a predetermined value which effectively acts to hold the stator 2. As understood from FIG. 8, it is confirmed that at both edge portions, in the width direction, of the contact region 41f2 (i.e., on both edge portions 41h of the protruding end surface 41f1 in the circumferential direction), the pressure of contact with the outer periphery of the stator 2 (the outer periphery of the back yoke 2a) is higher than that of the other region.

The edge portions 41h imply regions having a predetermined width inward from both edge portions of the protruding end surface 41f1 in the circumferential direction. FIG. 8 shows a range thereof.

Moreover, in this embodiment, as shown in FIG. 2, each protrusion 41f is formed in a circumferential angle range shifted from the angle range in which the fastening portion 41c is formed. This angle range implies an angle around the rotation axis line O of the rotor 3 described later.

Furthermore, in this embodiment, as shown in FIG. 2, each protrusion 41f is formed in a circumferential angle range shifted from the angle range in which the fixing portion (41d1, 41d2, 44a1, 44a2) is formed. This angle range also implies an angle around the rotation axis line O of the rotor 3 described later.

The second casing 42 is fastened to the first casing 41 via the fastening portions 41c formed at plural positions spaced apart in the circumferential direction at the end portion of the first casing 41. The second casing 42 is formed, for example, in a cylindrical shape with an open end, i.e., one end open on the opposite side to the side where the first casing 41 is fastened. From the opening, the compression mechanism 20 is housed in the second casing 42. The opening of the second casing 42 is closed by the compression mechanism cover 44. The second casing 42 is composed of a cylindrical portion 42a and a bottom wall portion 42b on one end side thereof, and the compression mechanism 20 is housed in a space defined by the cylindrical portion 42a and the bottom wall portion 42b. The bottom wall portion 42b forms a partition wall that partitions the inside of the first casing 41 from the inside of the second casing 42. Also, a through hole is formed in the radially central portion of the bottom wall portion 42b, through which the other end portion of the rotation axis 3a of the electric motor 10 is inserted, and a fitting portion is formed there so as to fit the bearing 45 supporting the other end of the rotation axis 3a.

Although not shown, the cylindrical portion 42a of the second casing 42 has plural through holes for inserting bolts to fasten the second casing 42 to the first casing 41, at positions corresponding to the screw holes 41c1 of the first casing 41. In the cylindrical portion 42a, the portion with the through hole is thicker than other portions where the through hole is not formed. The bolt is inserted through each through hole and screwed into the screw hole 41c1 of the first casing 41, whereby the first casing 41 and the second casing 42 are fastened together.

Also, although not shown, a refrigerant suction port and a refrigerant discharge port are formed in the casing 40. For example, refrigerant sucked from the suction port flows through the first casing 41 and is sucked into the second casing 42. As a result, the electric motor 10 is cooled by the sucked refrigerant, and the refrigerant compressed by the compression mechanism 20 is discharged from the discharge port.

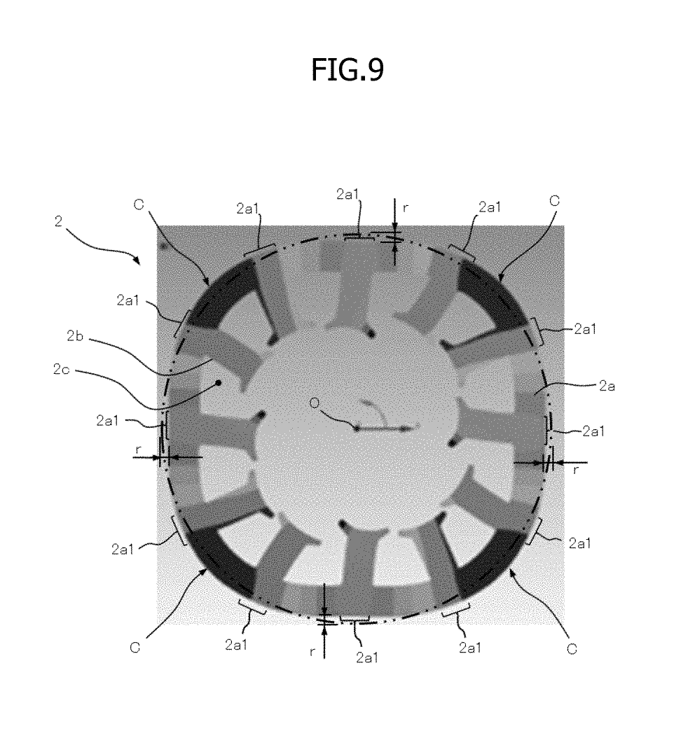

Next, referring to FIG. 9, described is the result of analyzing the deformation of the stator 2 when an electromagnetic force is applied to the stator 2 in the 8-pole (magnetic pole) 12 slot electric motor 10 according to this embodiment. Here, FIG. 9 shows the deformation of the stator 2 at a certain moment, on an enlarged scale (exaggerated form) for explicitly showing the deformation thereof.

As indicated by the two-dot chain line in FIG. 9, the stator 2 is circular in outer shape when no electromagnetic force is applied. It can be seen that when the electromagnetic force is applied, the stator 2 is deformed into substantially square in outer shape. Although not shown, the stator 2 is deformed into substantially square in outer shape at another moment as well. At this time, the positions of four corners C of a rough square are simultaneously moved around the rotation axis line O of the rotor 3 according to the phase of current, etc. In addition, it is confirmed that the teeth 2b of the stator 2 deform largely because the electromagnetic force is applied to the teeth 2b in the direction of the rotation axis line O. Therefore, each tooth back portion 2a1, located behind the teeth 2b to form a part of the outer periphery of the back yoke 2a (i.e., the outer periphery of the stator 2), is deformed more than the other portions of the outer periphery of the back yoke 2a, and vibrates with an amplitude r that varies depending on the material thereof, the magnitude of the electromagnetic force, and the like.

The shrink-fit margin between the stator 2 and the first casing 41 is set in consideration of the amplitude r, the temperature when in use, and the like so that the stator 2 can be used being properly held within the first casing 41. When each corner C is located in the region of a gap 46 formed between the first casing 41 and the stator 2, the projecting length (dimension in the direction of inner diameter) of the protrusion 41f is set so that each corner C does not contact the inner periphery of the peripheral wall portion 41a of the first casing 41.

Here, as shown in FIG. 1, it is necessary that the protrusion 41f is formed wide in order to secure the force of holding the stator 2. Thus, the respective tooth back portions 2a1 partially overlap the contact region 41f2 as the shrink-fit position. Since each tooth back portion 2a1 suffers from relatively large deformation, in case the tooth back portions 2a1 have to partially overlap the shrink-fit position this way, a special measure should be taken to reduce transmission of vibrations.

For that purpose, in this embodiment, as shown in FIGS. 2 and 8, a contact tooth back portion 2a11 out of each tooth back portion 2a1, which comes into contact with the protruding end surface 41f1 (specifically, the contact region 41f2), is formed within the circumferential angle range θ in which the protruding end surface 41f1 is located, in a region except the edge portions 41h that are located on both sides of the protruding end surface 41f1 in the circumferential direction, and receive a high contact pressure.

Specifically, the effective contact pressure region 41f3 having a contact pressure not smaller than a predetermined value that effectively acts to hold the stator 2 is confirmed beforehand, and angular positions of the stator 2 and the protrusion 41f are determined so as to avoid as far as possible both end portions, in the width direction, of the effective contact pressure region 41f3.

More specifically, the angular position of the stator 2 may be determined first, and then the angular position of the protrusion 41f may be appropriately determined according to the angular position of the stator 2. Alternatively, the angular position of the protrusion 41f is determined first and then, the angular position of the stator 2 may be appropriately determined according to the angular position of the protrusion 41f. As a result, the contact tooth back portion 2a11 out of the tooth back portion 2a1, which is a direct source of vibrations, can contact the contact region 41f2 at the central portion of the contact region 41f2, which receives a relatively low contact pressure.

Next, a brief description will be given of the action of restraining the vibration transmission in the electric compressor 1 according to this embodiment. When an alternate current is supplied from the inverter 30 to the electric motor 10, an electromagnetic force acts on the stator 2. At this time, as shown in FIG. 8, the stator 2 is deformed into substantially square in outer shape and vibrates radially at the amplitude r in each tooth back portion 2a1. The vibrations are transmitted from the contact tooth back portion 2a11 to the first casing 41 via the central portion of the contact region 41f2 having a low contact pressure, and then are transmitted to the respective fixing portions (41d1, 41d2) for fixing the first casing 41 to the vehicle while vibrating a thin wall portion of the peripheral wall portion 41a to reduce the vibration energy. However, since the contact tooth back portion 2a11 is arranged in a region except the edge portion 41h having a high contact pressure, direct transmission of vibrations from the tooth back portion 2a1 to the protrusion 41f is restrained. Besides, since the vibration energy generated by the vibration of the stator 2 is sufficiently reduced during this vibration transmission, when transmitted to the vehicle via each fixing portion (41d1, 41d2), the vibration energy is decreased enough.

According to the electric compressor 1 of this embodiment, although a part (i.e., the contact tooth back portions 2a11) of the plural tooth back portions 2a1 overlap the shrink-fit positions, each contact tooth back portion 2a11 is provided in a region except the edge portions 41h on both sides, in the circumferential direction, of the protruding end surface 41f1 within the circumferential angle range θ in which the protruding end surface 41f1 is located. Therefore, the contact tooth back portions 2a11 can be formed in a region except particularly each edge portion 41h of the protruding end surface 41f1, which is more susceptible to a high pressure of contact with the back yoke 2a, within the above angle range θ in which the contact pressure is relatively low. As a result, vibration transmission from the contact tooth back portion 2a11 to the protrusion 41f can be restrained. In this way, it is possible to provide the electric compressor 1 capable of appropriately restraining vibration transmission when the tooth back portion 2a1 overlaps the shrink-fit position.

Also, in the electric compressor 1 of this embodiment which has three shrink-fit points, at a certain moment, only one of the four corners C will overlap one of the three protrusions 41f1. Then, the remaining three corners C are located in the region of the gap 46 (see FIG. 1), being free without vibrating the first casing 41. Therefore, since the positions of all corners C never overlap the protrusions 41f at the same time, it is possible to effectively reduce the transmission (amount) of vibrations generated in the stator 2 to the casing 40. As a result, the 8-pole, 12-slot electric compressor 1, having three shrink-fit points, can effectively reduce the vibration transmission, as well as restrain the generation of radiated sound resultant from the vibration of the casing 40.

Also, in this embodiment, the fixing portion 41d is provided, which protrudes from the outer periphery of the casing 40 and is used for fixing the casing 40 to the installation target, and the protrusion 41f is formed within a circumferential angle range shifted from the angle range in which the fixing portion 41d is formed. This makes it possible to keep the protrusion 41f, at which point the vibrations of the stator 2 are transmitted to the casing 40, away from the fixing portion 41d, so that the vibration transmission path is extended as much as possible to attenuate (consume) the vibration energy in the course of vibration transmission, hereby more effectively restraining the vibration transmission to the installation target.

Also, in this embodiment, the casing 40 includes the first casing 41 for housing the electric motor 10 and the second casing 42 fastened to the first casing 41 through the fastening portions 41c formed at plural positions spaced apart in the circumferential direction at the end of the first casing 41, and the protrusion 41f is formed within a circumferential angle range shifted from the angle range in which the fastening portion 41c is formed. Thus, the protrusion 41f, at which point the vibrations of the stator 2 are transmitted to the first casing 41, can be arranged in the thin wall portion of the peripheral wall 41a of the first casing 41 in a region except the portion firmly fastened by fastening bolts or the like. Thus, it is possible to vibrate the thin wall portion of the peripheral wall 41a to effectively consume and reduce the vibration energy transmitted from the stator 2. As a result, the vibration transmission to the vehicle can be further effectively reduced.

Here, when setting three shrink-fit positions, which are the minimum number of shrink-fit positions, in order to reduce the vibration transmission as described above, the force of holding the stator 2 has to be increased at each position compared with the case where four or more shrink-fit positions are set. In order to increase the holding force, the protrusion 41f may be formed wider so as to increase the contact region 41f12 or the shrink-fit margin (calculated by subtracting the inner diameter of the protruding end surface 41f1 from the outer diameter of the stator 2 at the shrink-fit portion when the stator 2 is not housed in the first casing 41) may be increased. However, the protrusion 41f may not possibly be formed wide due to some limitations. On the other hand, if a large shrink-fit margin is set, there is concern that the margin increases at low temperature and an excessive stress is applied to shrink-fit parts, especially the casing 40 (first casing 41), lowering the durability.

In order to avoid such a situation, according to a second embodiment described below, it is possible to increase the holding force while maintaining the width of the protrusion 41f1 formed and the shrink-fit margin.

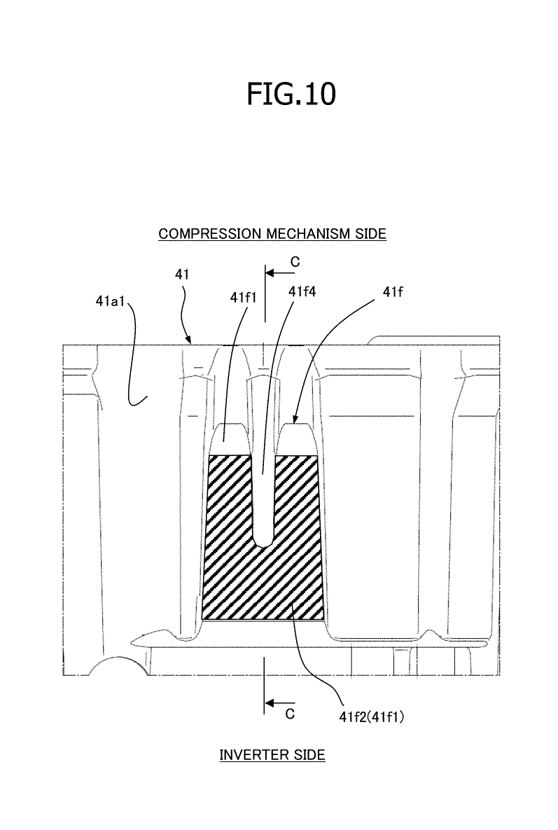

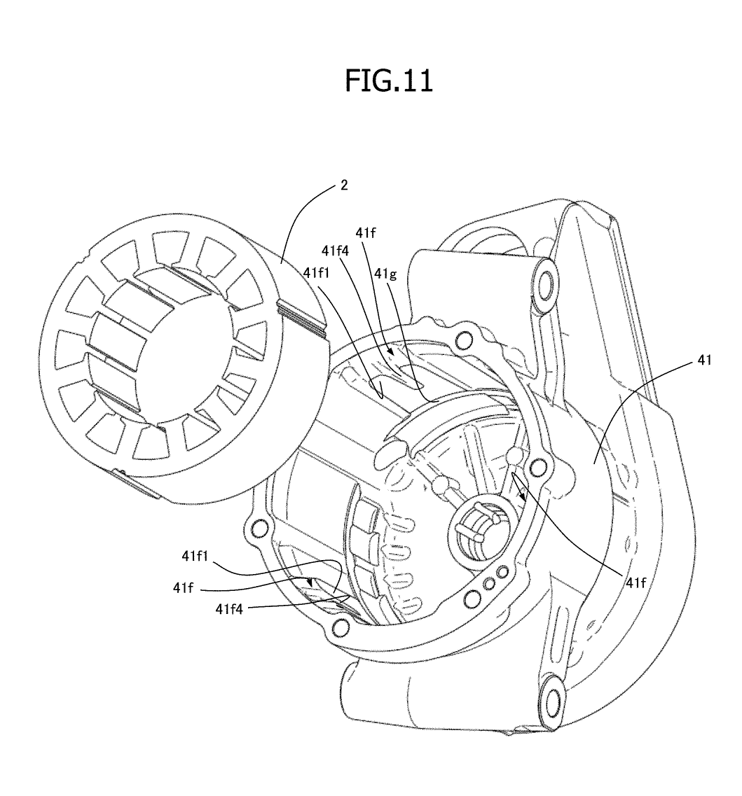

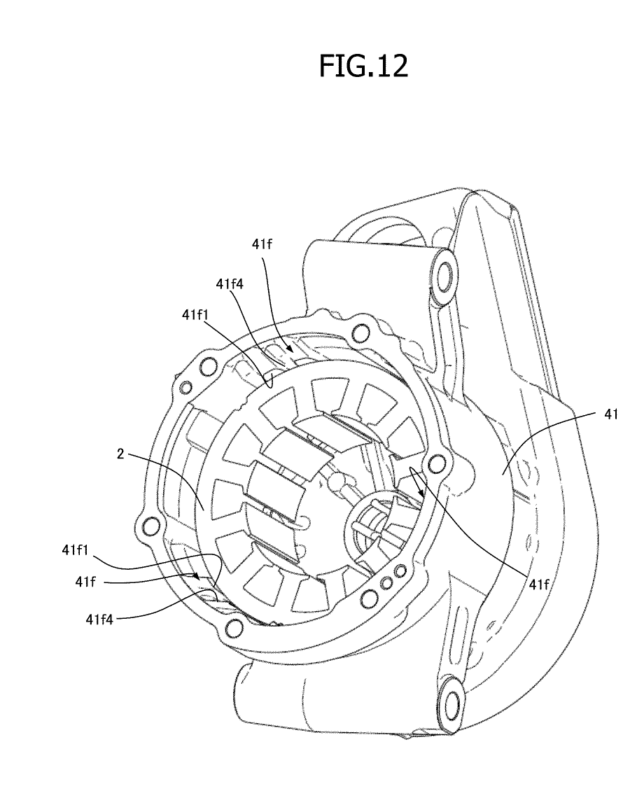

FIG. 10 shows the first casing 41, as viewed in the same direction as FIG. 4, of the second embodiment of the present invention. FIG. 11 is an exploded perspective view of the stator 2 and the first casing 41 and FIG. 12 is a perspective view of the electric motor in which the stator 2 is housed in the first casing 41. Note that the same components as in the first embodiment are given similar reference numerals or symbols. A description thereof is omitted here and only different components from the first embodiment are explained below.

In the second embodiment, as shown in FIGS. 10 to FIG. 12 above, a groove 41f4 is formed in the circumferentially central portion of each protrusion 41f, extending from the one end side in the axial direction of the casing 41 (the compression mechanism 20 side) toward the other end side (the inverter 30 side). As shown in FIGS. 10 and 11, the groove 41f4 is open at one end in the axial direction as well as closed at the other end. The groove is formed with substantially a half of the entire length of the protrusion 41f in the axial direction. As a result, the protruding end surface 41f1 of the protrusion 41f is formed in a U shape.

The protruding end surface 41f1 is exposed (see FIG. 12), not in contact with the outer periphery of the stator 2, at one end portion in the axial direction where one end side (the compression mechanism 20 side) of the groove 41f4 in the axial direction is open, and also comes into contact, at the other end side (the inverter 30 side) in the axial direction, with the outer periphery of the stator 2. In FIG. 10, the U-shaped contact region 41f2 of the protruding end surface 41f1 is hatched, which comes into contact with the outer periphery of the stator 2 and is used substantially as a shrink-fit position.

In the second embodiment, as described above, the groove 41f4 extending from one end side in the axial direction to the other end side is formed in the circumferentially central portion of each protrusion 41f.

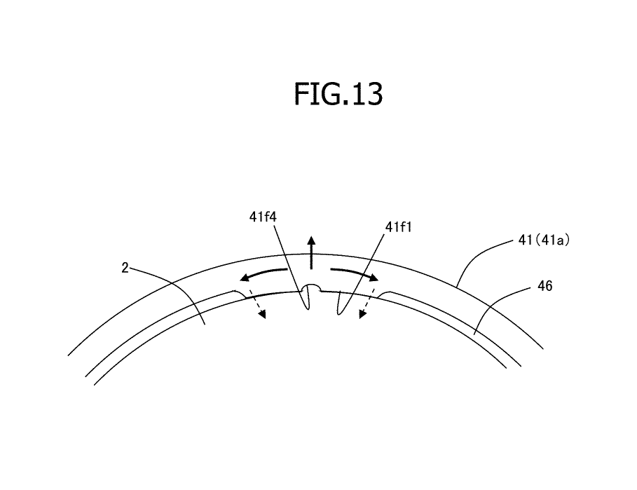

By forming the groove 41f4 in the protrusion 41f as described above, after the shrink-fitting, the force acting in the direction of outer diameter is applied to, as indicated by solid arrows in FIG. 13, the circumferentially central portion that becomes thin because of the formation of the grooves 41f4 of the protrusion 41f, and a tensile force is applied to both sides of the groove 41f4, pulling apart them radially outward. As a result, as indicated by the dotted arrow in FIG. 13, a moment force is generated in the direction in which the edge portions 41h on both sides of the protruding end surface 41f1 in the circumferential direction bend inward on the groove 41f4 portion. Thus, the contact pressure between the edge portion 41h on both sides in the circumferential direction of the protruding end surface 41f1 and the outer periphery of the stator 2 (the outer periphery of the back yoke 2a) increases compared with the first embodiment.

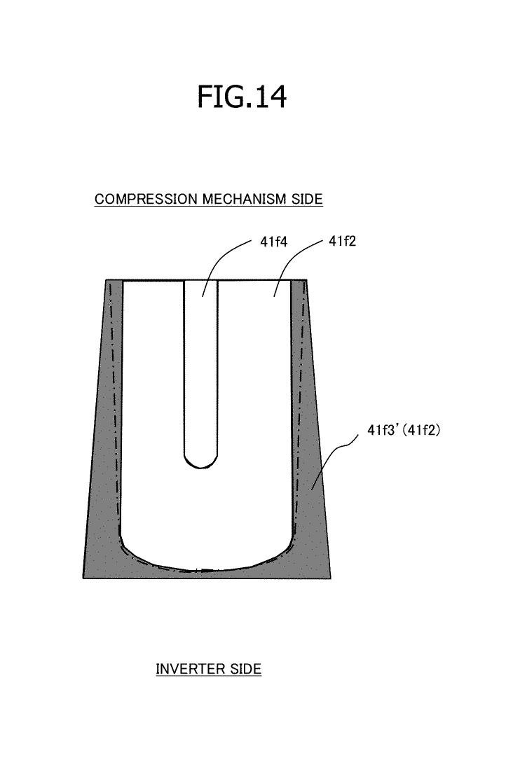

FIG. 14 is a conceptual diagram showing in shades the distribution of the contact pressure applied, after shrink-fitting, to the substantial shrink-fit position, that is, the U-shaped contact region 41f2, of the protruding end surface 41f1 having the groove 41f4 as shown in FIG. 10. In FIG. 14, a dark area indicates an effective contact pressure region 41f3′ with a contact pressure not smaller than a predetermined value which effectively acts to hold the stator 2. The dash line in FIG. 14 represents the boundary with the effective contact pressure region 41f3 of the first embodiment, which has no groove. A region outside the dash line corresponds to the effective contact pressure region 41f3 in the first embodiment. It is confirmed that, by forming the groove 41f4 as in the second embodiment, the effective contact pressure region increases and the effective contact pressure region can be largely expanded particularly at both edge portions on the side where the groove 41f4 of the protruding end surface 41f1 is open.

As in the second embodiment, the groove 41f4 extending from one end side in the axial direction to the other end side is formed at the circumferentially central portion of each protrusion 41f, making it possible to increase the contact pressure between the protruding end surface 41f1 and the outer periphery of the stator 2 at the shrink-fit portion without increasing the width of the protrusion 41f and the shrink-fit margin compared with the first embodiment, and to satisfactorily maintain the durability of the shrink-fit parts, particularly the first casing 41 while ensuring the sufficient force of holding the stator 2.

Although the contact pressure can be increased properly by setting the appropriate length of the groove 41f4, for example, when a groove is formed passing through both ends of the protrusion in the axial direction, the two protrusions are separately located on both sides of the groove, and the aforementioned action (generation of a moment force that causes inward bending on the groove) is impossible.

Also, if the groove is closed at both ends, the same effect as the groove 41f4 open only at one end can be achieved to some extent, but it is difficult to form the groove by casting, and additional cutting work is required.

Thus, as in this embodiment, it is advantageous from the viewpoint of its function and production to form the groove 41f4 with one end open and the other end closed so that the contact region of the shrink-fit portion has a U-shape.

In the above embodiments, the stator 2 has been described as being disposed in contact with the mounting seat 41g (see FIGS. 6 and 11) formed along the inner periphery 41a1 of the first casing 41. However, the present invention is not limited thereto, and a spacer having a proper thickness may be provided between the mounting seat 41g and one end surface of the stator 2 to dispose the stator 2. As a result, as shown in FIGS. 8 and 14, the contact tooth back portion 2a11 can be placed also in a region except the lower-end portion (the inverter 30 side) of the effective contact pressure region 41f3, 41f3′ of the contact region 41f2. Thus, the transmission of vibrations from the contact tooth back portion 2a11 to the protrusion 41f can be more effectively restrained.

In each of the above embodiments, the protrusion 41f is formed in each angle range shifted from the angle range in which the fixing portion 41d is formed. However, the present invention is not limited thereto, and the protrusion may overlap this range partially. Furthermore, although the protrusion 41f is formed in each circumferential angle range shifted from the angle range in which the fastening portion 41c is formed, the present invention is not limited thereto, and the protrusion 41f may be partially formed in an angle range overlapping this angle range.

In each of the above embodiments, the present invention is applied to the configuration in which the rotor 3 has eight magnetic poles, the stator 2 has twelve slots, and the protrusion 41f of the casing 40 is formed protruding at three positions spaced apart in the circumferential direction. However, the present invention is not limited thereto and is applicable to, for example, the configuration in which the rotor 3 has six magnetic poles, the stator 2 has nine slots, and the protrusion 41f of the casing 40 is formed protruding at four positions spaced apart in the circumferential direction. In this case as well, the vibration transmission to the installation target can be effectively reduced.

Also, it is possible to appropriately determine the number of magnetic poles of the electric motor 10, the number of slots 2c, the number of protrusions 41f, the number of fastening portions 41c, the number of fixing portions 41d, the positional relationship between the protrusion 41f and the fastening portion 41c, and the positional relationship between the protrusion 41f and the fixing portion 41d. By disposing the contact tooth back portion 2a11 in a region except the edge portion 41h within the circumferential angle range θ where the protruding end surface 41f1 is located, an advantageous effect can be obtained, which can restrain the transmission of vibrations from the contact tooth back portion 2a11 to the protrusion 41f.

Also, the scroll type compressor is given as an example of the compression mechanism 20 of the electric compressor 1. The present invention is not limited thereto and can be applied to an appropriate type electric compressor such as a swash-plate compressor.

The preferred embodiments of the present invention have been described above, but the present invention is not limited to the above embodiments and allows various changes and modifications on the basis upon the technical ideas of the invention.

### REFERENCE SYMBOL LIST

1 electric compressor
2 stator
2a back yoke (yoke portion)
2a1 tooth back portion
2a11 contact tooth back portion
2b tooth (tooth portion)
2c slot
3 rotor
10 electric motor
40 casing
41 first casing
41c fastening portion
41d fixing portion
41f protrusion
41f1 protruding end surface
41f4 groove
41h edge portion

1. An electric compressor which is driven by an electric motor and compresses refrigerant, and in which the electric motor is housed in a cylindrical casing, the motor including a stator having an annular yoke portion and a tooth portion formed protruding at a plurality of positions spaced apart in a circumferential direction of an inner periphery of the yoke portion, and a rotor disposed radially inside the stator, the electric compressor comprising
a protrusion formed protruding at a plurality of positions spaced apart in a circumferential direction of an inner periphery of the casing, which has a protruding end surface that comes into contact with an outer periphery of the yoke portion and has a larger width than the tooth portion and which is used as a shrink-fit position with the yoke portion,
wherein a contact tooth back portion, which comes into contact with the protruding end surface, out of a plurality of tooth back portions each disposed behind the tooth portion to constitute a part of the outer periphery of the yoke portion, is formed in a region except both edge portions of the protruding end surface in a circumferential direction within a circumferential angle range in which the protruding end surface is located.

2. The electric compressor according to claim 1, wherein a groove is formed in a circumferentially central portion of the respective protrusions, extending in an axial direction of the casing.

3. The electric compressor according to claim 2, wherein the groove is open at one end in the axial direction of the respective protrusions and is closed at the other end so as to form the protruding end surface in a U-shape.

4. The electric compressor according to claim 1, further comprising:
a fixing portion formed protruding from an outer periphery of the casing and configured to fix the casing to an installation target,
wherein the protrusion is formed within a circumferential angle range shifted from an angle range in which the fixing portion is formed.

5. The electric compressor according to claim 1, wherein the casing includes at least a first casing for housing the electric motor and a second casing fastened to the first casing through a fastening portion formed at a plurality of positions spaced apart in the circumferential direction at an edge portion of the first casing,
wherein the protrusion is formed in a circumferential angle range shifted from an angle range in which the fastening portion is formed.

6. The electric compressor according to claim 1, wherein the rotor includes eight magnetic poles,
the stator has twelve slots open on the rotor side, and
the protrusion of the casing is formed protruding at three positions spaced apart in the circumferential direction.

7. The electric compressor according to claim 1, wherein the rotor includes six magnetic poles,
the stator has nine slots open on the rotor side, and
the protrusion of the casing is formed protruding at four positions spaced apart in the circumferential direction.
